(19) United States
(12) Patent Application Publication
(10) Pub. No.: US 2001/0019930 A1
(43) Pub. Date: Sep. 6, 2001

(54) Non-woven fabric material with electrostatic capacity and cloth for dry-cleaning surfaces produced with this material

(76) Inventor: Simone Masetti, Prato (IT)

Correspondence Address: YOUNG & THOMPSON, 745 SOUTH 23RD STREET 2ND FLOOR, ARLINGTON, VA, 22202

(21) Appl. No.: 09/785,316

(22) Filed: Feb. 20, 2001

(30) Foreign Application Priority Data
Feb. 18, 2000 (IT) MI 2000A 000288

(51) Int. Cl. B32B 5/26; D04H 1/00; D04H 3/00; D04H 5/00; D04H 13/00

(52) U.S. Cl. 442/344; 442/381; 442/361

(57) ABSTRACT

A cloth for dry-cleaning surfaces in general, with the capacity to develop an electrostatic charge during use conferred by the non-woven fabric material of which it is composed, due to the presence of synthetic material fibers with different denier (yarn count).

Compared with known cloths for dry-cleaning surfaces, the one according to the invention has the advantage of acquiring an electrostatic charge autonomously, thus superseding the traditional need to resort to the use of specific auxiliary chemical additives.

### DESCRIPTION

The present invention concerns a non-woven fabric material with the capacity to acquire an electrostatic charge, and a cloth for dry-cleaning surfaces produced with this material.

Dry-cleaning of surfaces in general, such as the surfaces of furniture, floors and similar, is commonly performed using cloths, which have a certain degree of electrostatic charge, efficacious for attracting dust.

Traditional cloths for dry-cleaning surfaces are normally composed of non-woven fabric materials, formed of fibres all with the same denier or count. The capacity to develop an electrostatic charge is given to these materials either through treatment with auxiliary chemical agents (absorbed by or sprayed onto the surface of the cloth) or through integration of these chemical agents (for example in the form of latexes or other types of chemical products) directly within the structure of the non-woven fabric material, performed at the time the material is manufactured.

Therefore, the various cloths mentioned above all require the use of auxiliary or additional chemical products in relation to the basic structure of the fibres composing the non-woven fabric material, required to give the product the quantity of electrostatic charge necessary to be able to attract dust.

Consequently the cloth produced with known non-woven fabric materials involves additional costs, depending on the auxiliary chemical product utilized and any integration of this into the material at the time the cloth is manufactured. Moreover, in particular, the disadvantage of traditional cloths incorporating a latex that has acquired electrostatic properties is that their cleaning action is limited in time in relation to the useful life of the latex. Once the latex has been consumed or exhausted, the cloth is no longer capable of developing the electrostatic charge required and must consequently be eliminated.

Therefore, the principal aim of the present invention is to provide a non-woven fabric material, which has an autonomous capacity to acquire an electrostatic charge, without the use of auxiliary or additional chemical products in relation to the fibres of which the material is composed.

The present invention also aims at providing a non-woven fabric material with the capacity to develop, even for lengthy periods of time, an electrostatic charge.

Another aim of the invention is to produce a non-woven fabric material with electrostatic capacity, which is less expensive than those currently in use, both as regards the cost of raw materials utilised and manufacturing costs.

Lastly, a further aim of the invention is to provide a cloth for dry-cleaning surfaces in general, provided with electrostatic capacities towards dust.

These and other aims are attained with the non-woven fabric material and the cloth in independent claims 1 and 22.

Preferred embodiments of the invention are said in the remaining claims.

Compared with the known materials of the type indicated above, the advantage of the material according to the invention is that it has the capacity to acquire an electrostatic charge autonomously, superseding the traditional need to resort to the use of auxiliary chemical agents.

Moreover, the cloth produced with this material has a lasting capacity to develop an electrostatic charge and is also less expensive than those currently in use. These and other aims, characteristics and advantages are obtained with the non-woven fabric material and with the cloth according to the present invention, illustrated, merely as an unlimited example, in the figures of the enclosed drawings. In these:

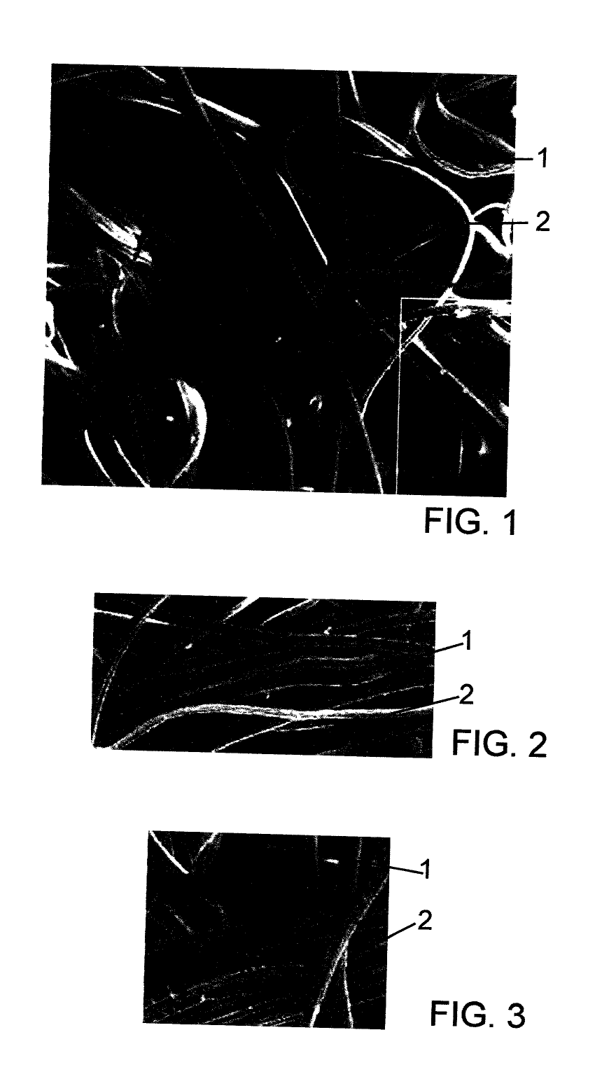

FIG. 1 illustrates a photograph on the electronic microscope of 15 kV enlargements of a non-woven fabric material according to the invention;

FIGS. 2 and 3 illustrate photographs on the electronic microscope of variants of the material in FIG. 1; and

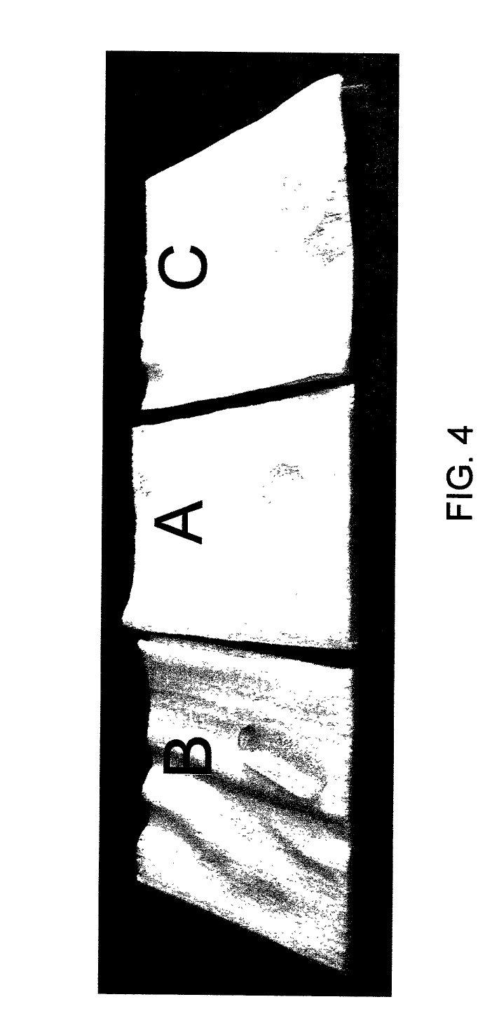

FIG. 4 illustrates samples of cloth utilized for a comparative experiment on the electrostatic capacity possessed by the material of the invention.

The non-woven fabric material illustrated in FIG. 1 is formed of a plurality of fibres 1,2 in synthetic material, for example polyolefinic fibres (such as polypropylene), polyester, polyamide, polyacrylic and similar, with a different denier or count.

In the present case, fibres 1 in polyester with a count of 1.5 or 1 denier, mixed with small fibres of around 0.14 denier, were utilised. The latter were preferably obtained by dividing 2.2 denier polyester fibres into sixteen parts. In particular, this division was produced using the mechanical action of water nozzles. Then again, cohesion between fibres was obtained using a water-based process known as low density “Spunlace/hydroentangled”.

In this way a relatively elastic non-woven fabric material is prepared, in which vibration of the small fibres 2 is obtained through rubbing inside the interspaces remaining empty between larger fibres 1, which are more rigid and thus less flexible.

Essentially, the use of fibres with different deniers causes different tensions inside the fibrous structure of the non-woven fabric, generated by rubbing this, for example on a surface. Reciprocal interference between the fibres of different deniers, and particularly different levels of elongation, stretch and vibrations of the small fibres 2 against the fibres 1 with larger denier or count, give the non-woven fabric the capability of developing an electrostatic charge. As can be easily understood from the explanation above, this is intrinsic to the very structure of the non-woven fabric thus composed and, therefore, does not require any additional component in order to take place.

To obtain this effect, the ratio between the denier or count of the larger fibres and the denier or count of the thinner fibres must be at least 2:1.3. This ratio may, for example, range from 2:1 to 36:1 and preferably from 7:1 to 11:1.

As can be seen in FIGS. 2 and 3, the relative quantity between fibres 1 and 2 which become part of the structure of the non-woven fabric material according to the invention can be chosen in a different manner.

In fact, this material's capacity to develop an electrostatic charge through rubbing also depends on the extent or size of the surface created by the fibres with different deniers.

For example, an efficacious structure for the purposes of the invention is one which, in a non-woven fabric of 60 g/m², formed of a composition with 80% of 1 denier fibres and 20% of 0.14 denier fibres, supplies a surface of 144.924 m² of larger fibres 1 and 99.378 m² of small fibres 2 (about 68% of the surface of the non-woven fabric material is produced by the thinner fibres). More generally, at least 3%, and preferably 50% of the surface of the non-woven fabric material must be composed of fibres 2 with lower deniers.

Another parameter that influences the capacity of the invention material to acquire an electrostatic charge is its density, which must be kept below 1.3 g/cm³, preferably around 0.6 g/cm³. For example, a non-woven fabric material suitable for the purposes of the invention is one with a weight of 65 g/m², a thickness of 1.25 mm and a density of 0.52 g/cm³.

In fact, an increase in the density of the material causes a decrease in the capacity of the fibres to move and vibrate within the interwoven fabric, thus reducing the capacity to acquire the required level of electrostatic charge.

However, low density is associated with a reduction in the mechanical characteristics of the product. If necessary, this can be integrated optionally with a reinforcing mesh in polypropylene or similar, or it can be subjected to thermal consolidation, achieved by melting the bicomponent fibres either at the lowest melting point utilised in blend or by hot calendering in points.

Not only may the non-woven fabric material according to the invention be formed of two groups of fibres, distinguished by a different denier, but also of three or more groups. Nonetheless, the principle of the invention is not based on the quantity of the different groups of fibres of which the material is composed, but on the general principle of having created a non-woven fabric with fibres that are no longer all identical, but have different denier values.

Some examples of non-woven fabric materials produced according to the present invention are given in the table below. In these examples:

tests were performed by rubbing samples of the material on a polyester rug, in optimum weather conditions;

the capacity of the material to acquire an electrostatic charge is expressed in Volts; this corresponds to the measurement, performed in a Faraday cage, of the accumulation of electrostatic energy produced by this rubbing of the samples; values below 1 Volt are not deemed sufficient for the purposes of the invention;

fibres with the lowest denier (0.14 denier) were obtained by dividing fibres with a value of 2.2 denier into sixteen parts; all fibres are polyester;

the density of the material was kept, for all samples, at around 0.70 g/cm³.

| | | | | Material's |
|---|---|---|---|---|
| | | Denier | | capacity to |
| | | ratio | Surface | acquire an |
| | Composition | (large | of thin | electrostatic |
| | of the non-woven | fibres/thin | fibres (% | charge |
| Sample | fabric material | fibres) | of total) | (Volt) |
| 1 | 100% 1.5 denier fibres | 1:1 | — | 0.30 |
| 2 | 100% 1 denier fibres | 1:1 | — | 0.45 |
| 3 | 90% 1.5 denier fibres | 11.3:1 | 27% | 1.35 |
| | 10% 0.14 denier fibres | | | |
| 4 | 90% 1 denier fibres | 7.6:1 | 23% | 1.22 |
| | 10% 0.14 denier fibres | | | |
| 5 | 80% 1.5 denier fibres | 11.3:1 | 46% | 1.65 |
| | 20% 0.14 denier fibres | | | |
| 6 | 80% 1 denier fibres | 7.6:1 | 41% | 2.82 |
| | 20% 0.14 denier fibres | | | |
| 7 | 70% 1 denier fibres | 7.6:1 | 54% | 3.08 |
| | 30% 0.14 denier fibres | | | |
| 8 | 50% 1 denier fibres | 7.6:1 | 73% | 3.23 |
| | 50% 0.14 denier fibres | | | |
| 9 | 50% 1.5 denier fibres | 11.3:1 | 32% denier | 2.65 |
| | 30% 1 denier fibres | 7.6:1 | 24% denier | |
| | 20% 0.14 denier fibres | | 44% denier | |
| 10 | 50% 1 denier fibres | 11.3:1 | 36% denier | 2.95 |
| | 30% 0.8 denier fibres | 7.6:1 | 24% denier | |
| | 20% 0.14 denier fibres | | 40% denier | |

As can be seen in this table, materials composed of fibres with the same denier are unable to develop sufficient electrostatic charge to attract dust.

On the contrary, according to the invention, when the non-woven fabric material is prepared with fibres with different deniers, this assumes an electrostatic charge and the more equivalent the surface produced by the surface area of the fibres of different diameters (see sample no. 8), the larger this charge becomes.

With the non-woven fabric material described above it is possible to produce a cloth that can be used to dry-clean surfaces in general, susceptible to assuming a suitable electrostatic charge to retain dust efficaciously.

In the experiment shown in the photographs in FIG. 4 a sample of cloth A, produced according to the invention, was compared with similar cloths for dusting B and C of the traditional type. In particular:

cloth A was formed of a non-woven fabric material composed of 80% of 1 denier polyester fibres and 20% of 0.14 denier polyester fibres (sample 6 in the table above);

cloth B was formed of a non-woven fabric material composed of 100% of 0.8 denier polyester fibres, integrated with an acrylic latex at the time the cloth was manufactured; and

cloth C was formed of a non-woven fabric material composed of 100% of 1.5 denier polyester fabric.

These three cloths were all dampened with the same quantity of water poured from a glass. The presence of electrostatic charge was indicated by failure to absorb the water.

The experiment gave the following results:

cloth C, namely the non-woven fabric material composed solely of polyester fibres, all of the same denier or count, absorbed all the water that was poured: therefore, the cloth had no electrostatic charge;

Cloth B, namely the non-woven fabric material also formed of fibres with the same denier, but integrated with a latex capable of providing an electrostatic charge, showed that it had a hydro-repellent effect: in fact, the water lay on the fabric without being absorbed by it, thus indicating that the cloth had an electrostatic charge;

cloth A according to the invention behaved essentially in the same way as cloth B, thus proving that it also had an electrostatic charge; however, this charge was obtained without the use of chemical compounds added to the basic structure of the fibres of the non-woven fabric material of which the cloth was formed.

In substance, when the water molecule comes into contact with the field of electrical current generated by the cloth it cannot penetrate this, producing a hydro-repellent effect. This denotes the presence of an electrical field in samples A and B, while it is able to penetrate sample C owing to the field's lack of or low level of power.

1. Non-woven fabric material provided with the capacity to develop an electrostatic charge, characterised in that it is formed of fibres in synthetic material with different deniers or counts.

2. Material as claimed in claim 1, characterised in that the ratio between the denier or count of the largest fibres and the denier or count of the finest fibres is at least 2:1.3.

3. Material as claimed in claim 2, characterised in that the aforesaid ratio ranges from 2:1 to 36:1, preferably from 7:1 to 11:1.

4. Material as claimed in claim 1, characterised in that it is formed of a mixture of fibres (1) from 1 to 1.5 denier and fibres (2) with a fineness below 0.5 denier.

5. Material as claimed in one or more of the above claims, characterised in that at least 3% of its surface is formed of fibres with finer deniers/counts.

6. Material as claimed in one or more of claims 1 to 4, characterised in that at least 50% of its surface is formed of fibres with finer deniers/counts.

7. Material as claimed in one or more of the above claims, characterised in that it has a density of less than 1.3 g/cm³, preferably around 0.6 g/cm³.

8. Material as claimed in one or more of the above claims, characterised in that it has the capacity to acquire an electrostatic charge of at least 1 Volt.

9. Material as claimed in one or more of the above claims, characterised in that the aforesaid fibres are polyacrylic, polyamide, polyester or polypropylene fibres.

10. Material as claimed in one or more of the above claims, characterised in that it is formed of 90% of 1.5 denier polyester fibres and 10% of 0.14 denier polyester fibres.

11. Material as claimed in one or more of claims 1 to 9, characterised in that it is formed of 90% of 1 denier polyester fibres and 10% of 0.14 denier polyester fibres.

12. Material as claimed in one or more of claims 1 to 9, characterised in that it is formed of 80% of 1.5 denier polyester fibres and 20% of 0.14 denier polyester fibres.

13. Material as claimed in one or more of claims 1 to 9, characterised in that it is formed of 80% of 1 denier polyester fibres and 20% of 0.14 denier polyester fibres.

14. Material as claimed in one or more of claims 1 to 9, characterised in that it is formed of 70% of 1 denier polyester fibres and 30% of 0.14 denier polyester fibres.

15. Material as claimed in one or more of claims 1 to 9, characterised in that it is formed of 50% of 1 denier polyester fibres and 50% of 0.14 denier polyester fibres.

16. Material as claimed in one or more of claims 1 to 9, characterised in that it is formed of 50% of 1.5 denier polyester fibres, 30% of 1 denier polyester fibres and 20% of 0.14 denier polyester fibres.

17. Material as claimed in one or more of claims 1 to 9, characterised in that it is formed of 50% of 1 denier polyester fibres, 30% of 0.8 denier polyester fibres and 20% of 0.14 denier polyester fibres.

18. Material as claimed in one or more of claims 10 to 17, characterised in that the said 0.14 denier polyester fibres are obtained by dividing 2.2 denier polyester fibres into sixteen parts.

19. Material as claimed in one or more of the claims above, characterised in that it has a mesh of reinforcing material.

20. Material as claimed in one or more of claims 1 to 18, characterised in that it has bicomponent fibres or fibres with the lowest melting point.

21. Material as claimed in one or more of claims 1 to 20, characterised in that it has the capacity to acquire an electrostatic charge varying from 1.22 to 3.23 Volt.

22. Cloth for dry-cleaning surfaces in general with the capacity to develop an electrostatic charge during use, characterised in that it is produced with the non-woven fabric material as claimed in one or more of the claims above.
